(19) United States
(12) Patent Application Publication
(10) Pub. No.: US 2013/0089163 A1
(43) Pub. Date: Apr. 11, 2013

(54) DEVICE AND METHOD FOR GENERATING PILOT SEQUENCE

(71) Applicants: Zhongshan Zhang, Beijing (CN); Ming Lei, Beijing (CN)

(72) Inventors: Zhongshan Zhang, Beijing (CN); Ming Lei, Beijing (CN)

(73) Assignee: NEC (CHINA) CO., LTD., Beijing (CN)

(21) Appl. No.: 13/702,109

(22) PCT Filed: Jun. 14, 2011
(86) PCT No.: PCT/CN2011/075733

§ 371 Date: Dec. 5, 2012

(30) Foreign Application Priority Data
Sep. 6, 2010 (CN) 201010275073.3

(51) Int. Cl. H04L 5/00

(52) U.S. Cl. CPC H04L 5/00
USPC 375/295

(57) ABSTRACT

A device for generating a pilot sequence is provided. The device includes: a mapping information determining unit configured to determine periodic mapping information of the pilot sequence on subcarriers; and a pilot sequence generating unit configured to generate the pilot sequence by calculating phase information of the pilot sequence to be generated based on the periodic mapping information. A method and a device for estimating channel information are also provided.

### TECHNICAL FIELD

The present invention relates to wireless communication, and more particularly, to a device and method for generating a pilot sequence.

### BACKGROUND

In a Single Frequency Network (SFN), a number of transmitters transmit the same information to a single receiver using the same time and frequency resources. For example, the SFN based on Orthogonal Frequency Division Multiplexing (OFDM) modulation is widely used in Digital Audio Broadcast (DAB) and Digital Video Broadcast-Terrestrial (DVB-T) systems.

The most commonly applied orthogonal pilot arrangement scheme is to arrange pilot sequences orthogonally in frequency domain. With such pilot arrangement policy, the receiver can identify and demodulate the pilot sequences transmitted from different transmitters based on a set of frequency domain filters. In addition to the frequency domain orthogonality, other orthogonal policies such as time domain orthogonality, are also commonly adopted.

In order to improve the system's reliability in terms of multipath-combating, the SFN requires the receiver to have a highly accurate and highly reliable synchronization function. In the SNF based on OFDM modulation, the presence of Carrier Frequency Offset (CFO) will degrade the demodulation performance of the system. In the SFN, the system requires the receiver to be aware of Channel State Information (CSI) to achieve improved reception performance.

In the prior art, algorithms based on frequency domain filter are widely adopted. A frequency domain filter is provided at the receiver to detect and identify the pilots transmitted from the individual transmitters. However, conventional pilots are designed regardless of pilot-subcarrier mapping information. That is, the contents of the pilots are independent of the pilot-subcarrier mapping information. In this case, in the presence of a large CFO, the conventional algorithms based on frequency domain filters may not be capable of identifying and demodulating the pilot sequences correctly due to pilot position offset.

In other words, the conventional designs of pilot sequences are independent of the pilot-subcarrier mapping information. Typically, the system first generates pilot sequences, and then maps the generated pilot sequences onto reserved pilot subcarriers (the reserved pilot subcarriers are pre-configured by the system and their positions are known to the transmitters and the receiver). However, since the conventional pilot sequences do not contain the pilot-subcarrier mapping information, in the presence of a large CFO in the system, the performance of pilot sequence demodulation (based on frequency domain filter) will be significantly affected by the CFO or the demodulation may even fail due to the difference between the positions of the pilot subcarriers at the receiver and the default positions of the pilot subcarriers in the system.

### SUMMARY

In order to solve the above problem, a reliable pilot sequence generation device and method are provided. With the present invention, it is possible to avoid failure of pilot sequence detection due to the presence of a large CFO in the system. Such reliability is particularly important in a multipoint to point transmission environment (such as a SFN). In the present invention, the pilot sequence transmitted from each transmitter can be successfully identified and demodulated at the receiver no matter how large the CFO in the system is. Additionally, a method for estimating carrier frequency offset and channel information is also provided.

According to an aspect of the present invention, a device for generating a pilot sequence is provided. The device includes: a mapping information determining unit configured to determine periodic mapping information of the pilot sequence on subcarriers; and a pilot sequence generating unit configured to generate the pilot sequence by calculating phase information of the pilot sequence to be generated based on the periodic mapping information.

Preferably, the pilot sequence generating unit is configured to calculate a product of a number of the pilot sequence and the periodic mapping information and to calculate the phase information based on the product, thereby generating the pilot sequence.

Preferably, the pilot sequence generating unit is configured to calculate a product of the number of the pilot sequence, the periodic mapping information and a predefined factor, and to calculate the phase information based on the product, thereby generating the pilot sequence. The predefined factor includes a prime number which is no more than a total number of the subcarriers and is no less than a predetermined channel length.

Preferably, the pilot sequence generated by the pilot sequence generating unit has a constant modulus value.

According to another aspect of the present invention, a device for estimating a carrier frequency offset is provided. The device includes: a pilot sequence detecting unit configured to detect a pilot sequence from a received signal, the phase information of the pilot sequence containing periodic mapping information of the pilot sequence on subcarriers; a phase rotation vector estimating unit configured to estimate a phase rotation vector due to a carrier frequency offset from the detected pilot sequence; and a carrier frequency offset estimating unit configured to estimate the carrier frequency offset based on the estimated phase rotation vector.

Preferably, the phase rotation vector estimating unit is configured to generate a matrix associated with the pilot sequence and perform a matrix operation on the received signal, in order to filter out interference and noise and retain valid information of the pilot sequence, thereby generating the phase rotation vector.

Preferably, the phase rotation vector estimating unit includes an input for receiving channel information, the phase rotation vector estimating unit estimating the carrier frequency offset based on the estimated phase rotation vector and the channel information received on the input.

According to another aspect of the present invention, a device for estimating channel information is provided. The device includes: a pilot sequence detecting unit configured to detect a pilot sequence from a received signal, the phase information of the pilot sequence containing periodic mapping information of the pilot sequence on subcarriers; and a channel information estimating unit configured to estimate the channel information from the detected pilot sequence using a Least-Square algorithm.

Preferably, the channel information estimating unit includes an input for receiving a carrier frequency offset, the channel information estimating unit estimating the channel information from the detected pilot sequence based on the CFO received on the input using a Least-Square algorithm.

According to another aspect of the present invention, a method for generating a pilot sequence is provided. The method includes: a step of determining periodic mapping information of the pilot sequence on subcarriers; and a step of generating the pilot sequence by calculating phase information of the pilot sequence to be generated based on the periodic mapping information.

Preferably, the step of generating includes: calculating a product of a number of the pilot sequence and the periodic mapping information; and calculating the phase information based on the product, thereby generating the pilot sequence.

Preferably, the step of generating includes: calculating a product of a number of the pilot sequence, the periodic mapping information, and a predefined factor; and calculating the phase information based on the product, thereby generating the pilot sequence. The predefined factor includes a prime number which is no more than a total number of the subcarriers and is no less than a predetermined channel length.

Preferably, the generated pilot sequence has a constant modulus value.

According to another aspect of the present invention, a method for estimating a carrier frequency offset and channel information is provided. The method includes: a step of detecting a pilot sequence from a received signal, the phase information of the pilot sequence containing periodic mapping information of the pilot sequence on subcarriers; a step of initially estimating a CFO from the detected pilot sequence; a step of estimating the channel information from the detected pilot sequence based on the CFO using a Least-Square algorithm; and a step of estimating a phase rotation vector due to a carrier frequency offset from the detected pilot sequence based on the estimated channel information, and estimating the carrier frequency offset based on the estimated phase rotation vector.

Preferably, the step of estimating the channel information and the step of estimating the CFO are performed in cycle for at least two times.

With the pilot sequence according to the present invention, in the presence of a large CFO in a multipoint to point transmission system, it is possible to avoid failure of pilot sequence detection at the receiver due to the CFI in the prior art. Further, compared with the pilot detection based on frequency domain filter in the prior art, the pilot sequence detection process of the present invention is capable of avoiding loss of effective energy due to the presence of the CFO. In this way, the new pilot can achieve an improved CFO estimation accuracy.

The pilot sequence according to the present invention is very robust in pilot identification performance. The performance of pilot detection is independent of the CFO in the system. Thus, the pilot sequence of the present invention can be effectively applied to multipoint to point transmission environments such as SFN, OFDMA system and the like.

### BRIEF DESCRIPTION OF THE DRAWINGS

The above and other features of the present invention will be more apparent from the following detailed description taken in conjunction with the figures, in which:

FIG. 1 shows a schematic diagram of a wireless network system according to an embodiment of the present invention;

FIG. 2 shows a block diagram of a device for generating a pilot sequence according to an embodiment of the present invention;

FIG. 3 shows a schematic diagram illustrating the generation of pilot sequence according to an embodiment of the present invention;

FIG. 4 shows a schematic diagram illustrating the generation of pilot sequence according to another embodiment of the present invention;

FIG. 5 shows a block diagram of a device for estimating a carrier frequency offset according to an embodiment of the present invention;

FIG. 6 shows a block diagram of a device for estimating channel state information according to an embodiment of the present invention;

FIG. 7 shows a flowchart of a method for generating a pilot sequence according to an embodiment of the present invention;

FIG. 8 shows a flowchart of a method for estimating a carrier frequency offset according to an embodiment of the present invention;

FIG. 9 shows a flowchart of a method for estimating channel state information according to an embodiment of the present invention;

FIG. 10 shows a flowchart of a method for estimating a CFO and channel state information according an embodiment of the present invention;

FIG. 11 shows a schematic diagram illustrating the principle of a process for estimating a CFO and channel state information according an embodiment of the present invention;

FIG. 12 shows a graph illustrating the performance of carrier frequency offset estimation according to an embodiment of the present invention;

FIG. 13 shows a graph illustrating the performance of channel estimation according to an embodiment of the present invention; and

FIG. 14 shows a graph illustrating the bit error rate performance according to an embodiment of the present invention.

### DETAILED DESCRIPTION OF THE PREFERRED EMBODIMENTS

The principle and implementation of the present invention will be more apparent from the following descriptions of embodiments of the present invention with reference to the figures. It should be noted that the present invention is not limited to the following embodiments. In addition, descriptions of well known elements will be omitted for simplicity.

In a particular embodiment below, the pilot sequence of the present invention will be described with a SFN based on OFDM modulation. However, it can be understood that the present invention is not limited to the SFN based on OFDM modulation, but is also applicable in other wireless networks such as wireless networks based on orthogonal time division multiplexing modulation and the like.

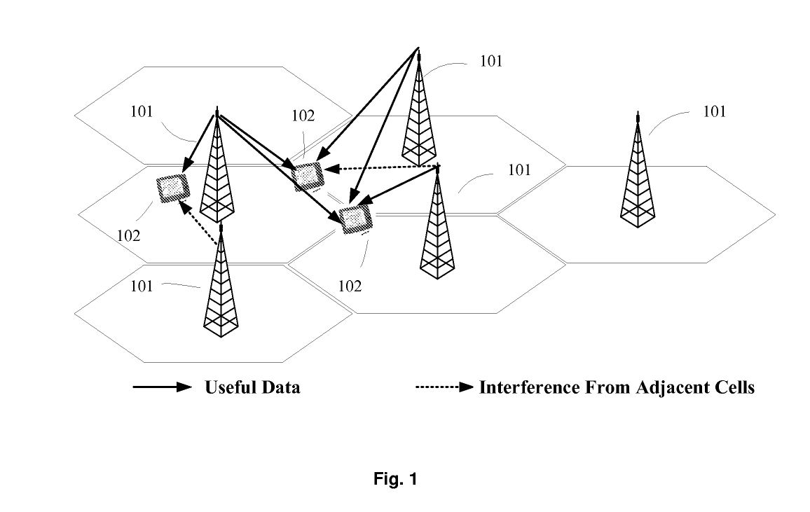

FIG. 1 shows a transmit/receive system of a SFN based on OFDM modulation according to an embodiment of the present invention. As shown in FIG. 1, several transmitters 101 share the same time and frequency resources and transmit the same information to a single receiver 102. Since more than one transmitter transmits over the same time and frequency resources, the pilot identification performance at the receiver is very important.

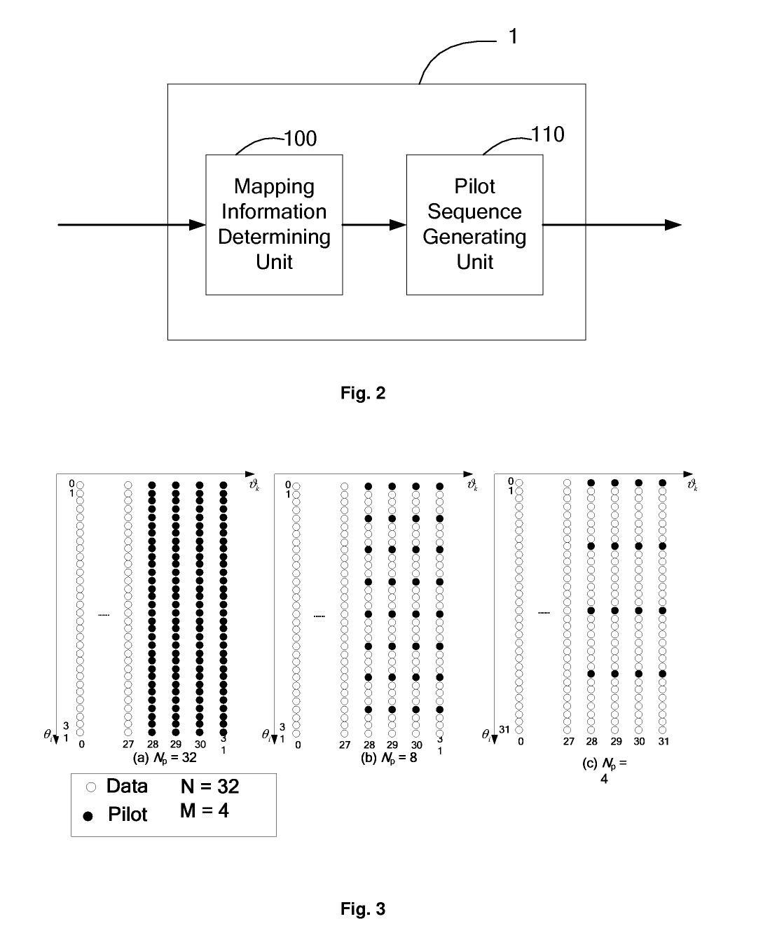

FIG. 2 shows a block diagram of a device 1 for generating a pilot sequence according to an embodiment of the present invention. As shown in FIG. 2, the device 1 for generating a pilot sequence includes a mapping information determining unit 100 and a pilot sequence generating unit 110. The mapping information determining unit 100 is configured to determine periodic mapping information of the pilot sequence on subcarriers (i.e., the positions of pilot subcarriers). The pilot sequence generating unit 110 is configured to generate the pilot sequence by calculating phase information of the pilot sequence to be generated based on a number of the device 1 itself (or a number of the pilot sequence transmitted by the device 1) and the pilot mapping information determined by the mapping information determining unit 100. That is, the pilot mapping information has been reflected in the content of the pilot sequence (in particular in the phase information of the pilot sequence).

FIG. 3 shows a schematic diagram illustrating the generation of pilot sequence according to an embodiment of the present invention. The pilot sequence generated according to the mapping scheme shown in FIG. 3 is particularly advantageous for the CFO estimation at the receiver, which will be detailed below.

As shown in FIG. 3, the mapping of the pilot sequence on the frequency domain subcarriers is periodic. It is assumed that each pilot sequence has a length of Nₚ, and the distance between any two adjacent pilot subcarriers is N/Nₚ, where N represents the total number of subcarriers in the system, i.e., the DFT length. Nₚ is not larger than N (Nₚ is typically smaller than N). It is further assumed that the positions of the pilot subcarriers are where (θ₁, . . . , θ_{N}_{ₚ}), where 0≦θ₁<θ_{N}_{ₚ}≦N−1.

The pilot sequence generating unit 110 can generate the pilot sequence using the following equation (1):

$${\tilde{x}}_{k}^{p} [ {θ}_{k .. i} ] = \sqrt{\frac{{E}_{p}}{{MN}_{p}}} {e}^{\frac{j 2 π {θ}_{k , i} {ϑ}_{k}}{N}} \\ s . t . 1 \leq k \leq M \leq N ; 1 \leq i \leq {N}_{p} \leq N : \\ {( {θ}_{2} - {θ}_{1} )}_{N} = … = {( {θ}_{{N}_{p}} - {θ}_{{N}_{p} - 1} )}_{N} = {( {θ}_{1} - {θ}_{{N}_{p}} )}_{N} \qquad ( 1 )$$

where Eₚ denotes the total pilot power and (x)_{N} denotes the residue of x mod N.

Channel information needs to be considered in the generation of the pilot sequence. In a frequency-selective fading channel, the pilot channel does not have a constant modulus. However, if the channel information is known, an effective pilot sequence obtained by multiplying the pilot sequence generated by the pilot sequence generating unit 110 with a channel fading factor has a constant modulus of

$$\sqrt{\frac{{E}_{p}}{{MN}_{P}}} ,$$

where M is the total number of the transmitters.

Table 1 shows examples of two pilot sequences generated according to the embodiment shown in FIG. 3. An optimal pilot for frequency offset estimation is generated (N=32,

$${β}_{M} = \sqrt{\frac{{E}_{p}}{{MN}_{P}}} ) .$$

TABLE 1
Nₚ = 4

| θₖ | θ_{k,1} = 0 | θ_{k,2} = 8 | θ_{k,3} = 16 | θ_{k,4} = 24 |
|---|---|---|---|---|
| 31 | β_{M} | ${β}_{M} {e}^{\frac{j 3 π}{2}}$ | β_{M}e^{jπ} | ${β}_{M} {e}^{\frac{j π}{2}}$ |
| 30 | β_{M} | β_{M}e^{jπ} | β_{M} | β_{M}e^{jπ} |
| 29 | β_{M} | ${β}_{M} {e}^{\frac{j π}{2}}$ | β_{M}e^{jπ} | ${β}_{M} {e}^{\frac{j 3 π}{2}}$ |

Nₚ = 8

| θₖ | θ_{k,1} = 0 | θ_{k,2} = 4 | θ_{k,2} = 8 | θ_{k,4} = 12 | θ_{k,5} = 16 | θ_{k,6} = 20 | θ_{k,7} = 24 | θ_{k,8} = 28 |
|---|---|---|---|---|---|---|---|---|
| 31 | β_{M} | ${β}_{M} {e}^{\frac{j 7 π}{4}}$ | ${β}_{M} {e}^{\frac{j 3 π}{2}}$ | ${β}_{M} {e}^{\frac{j 5 π}{4}}$ | β_{M} | ${β}_{M} {e}^{\frac{j 3 π}{4}}$ | ${β}_{M} {e}^{\frac{j π}{2}}$ | ${β}_{M} {e}^{\frac{j π}{4}}$ |
| 30 | β_{M} | ${β}_{M} {e}^{\frac{j 3 π}{2}}$ | β_{M}e^{jπ} | ${β}_{M} {e}^{\frac{j π}{2}}$ | β_{M} | ${β}_{M} {e}^{\frac{j 3 π}{2}}$ | β_{M}e^{jπ} | ${β}_{M} {e}^{\frac{j π}{2}}$ |
| 29 | β_{M} | ${β}_{M} {e}^{\frac{j 5 π}{4}}$ | ${β}_{M} {e}^{\frac{j π}{2}}$ | ${β}_{M} {e}^{\frac{j 7 π}{4}}$ | β_{M} | ${β}_{M} {e}^{\frac{j 5 π}{4}}$ | ${β}_{M} {e}^{\frac{j π}{2}}$ | ${β}_{M} {e}^{\frac{j 7 π}{4}}$ |

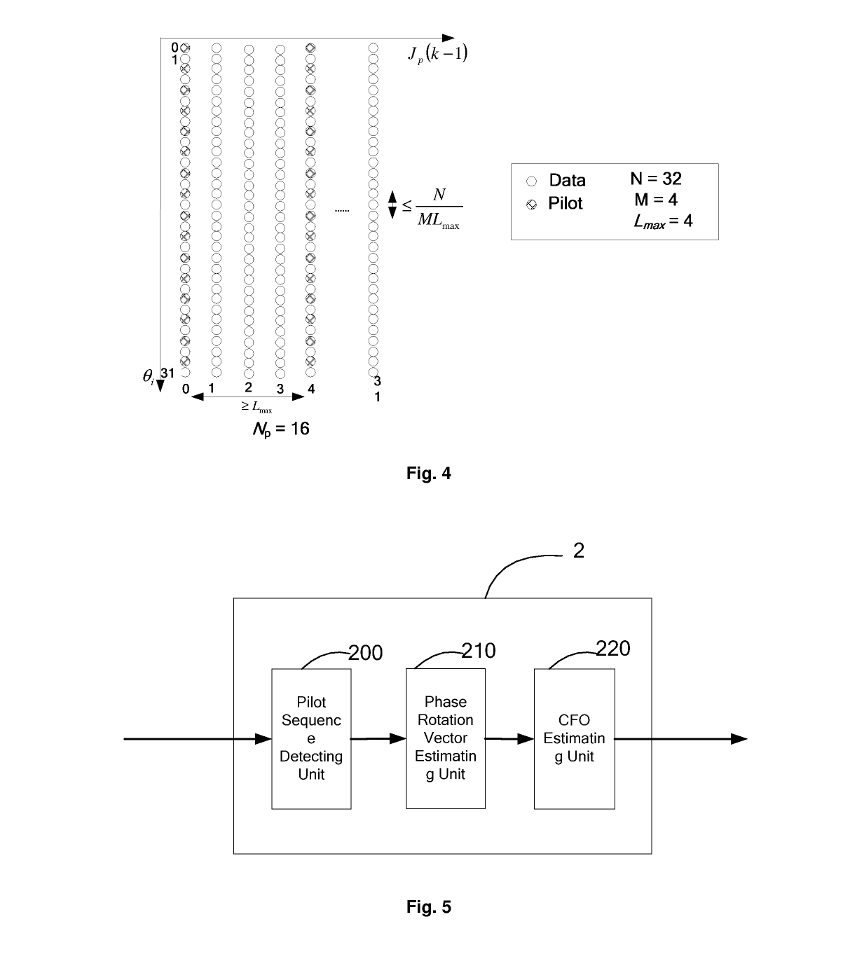

FIG. 4 shows a schematic diagram illustrating the generation of pilot sequence according to another embodiment of the present invention. The pilot sequence generated according to the mapping scheme shown in FIG. 4 is particularly advantageous for the channel estimation at the receiver, which will be detailed below.

As shown in FIG. 4, the mapping of the pilot sequence on the frequency domain subcarriers is periodic again. It is assumed that each pilot sequence has a length of Nₚ and the interval between any two adjacent pilot subcarriers is N/Nₚ, where N represents the DFT length. Nₚ is not larger than and is typically smaller than N. In this example, the optimal pilot sequence for channel estimation has a constant modulus. In particular, in this example, the pilot sequence generating unit 110 can generate the pilot sequence using the following equation (2):

$${[ {x}_{k}^{p} ]}_{{θ}_{k , i} {θ}_{k , i}} = \sqrt{\frac{{E}_{p}}{{MN}_{p}}} {e}^{\frac{j 2 n {ɛ}_{k , i} Ip ( k - 1 )}{N}} \\ s . t . 1 \leq k \leq M \leq N ; 1 \leq i \leq {N}_{p} \leq N : \\ {ML}_{max} \leq {N}_{p} \leq N , {MN}_{p} \leq N , \frac{N}{{N}_{p}} = integer \\ {I}_{p} \geq {L}_{max} , \frac{{θ}_{i} {J}_{p} ( k - {k}^{′} )}{N} \neq integer , \\ 1 \leq k \neq {k}^{′} \leq M \leq N ; \\ {( {θ}_{z} - {θ}_{1} )}_{N} = … = {( {θ}_{{N}_{p}} - {θ}_{{N}_{p} - 1} )}_{N} = {( {θ}_{1} - {θ}_{{N}_{2}} )}_{N} \qquad ( 2 )$$

Given a channel length of Lₘₐₓ, M×Lₘₐₓ cannot be larger than Nₚ, where M denotes the total number of transmitters. It is noted here that the following condition should be satisfied for Nₚ pilot subcarriers (θ₁, . . . , θ_{N}_{ₚ}):

$$\frac{{θ}_{i} {J}_{p} ( k - {k}^{′} )}{N} \neq integer$$

where Jₚ is a prime number smaller than N. The idea behind the above condition is to ensure that each pilot sequence has Nₚ, different pilot values, such that the orthogonality between any two pilot sequences can be satisfied.

Table 2 shows examples of two pilot sequences generated according to the embodiment shown in FIG. 4. An optimal pilot for channel estimation is generated

$$( N = 32 , M = 2 , {L}_{max} = 4 , {N}_{p} = 8 , {β}_{M} = \sqrt{\frac{{E}_{p}}{{MN}_{1}}} ) .$$

TABLE 2

| | | | | | | | | |
|---|---|---|---|---|---|---|---|---|
| k | θ_{k,1} = 0 | θ_{k,2} = 4 | θ_{k,3} = 8 | θ_{k,4} = 12 | θ_{k,5} = 16 | θ_{k,6} = 20 | θ_{k,7} = 24 | θ_{k,8} = 28 |

Jₚ = 5

| | | | | | | | | |
|---|---|---|---|---|---|---|---|---|
| 4 | β_{M} | ${β}_{M} {e}^{\frac{j 7 π}{4}}$ | ${β}_{M} {e}^{\frac{j 3 π}{2}}$ | ${β}_{M} {e}^{\frac{j 5 π}{4}}$ | β_{M}e^{jπ} | ${β}_{M} {e}^{\frac{j 3 π}{4}}$ | ${β}_{M} {e}^{\frac{j π}{2}}$ | ${β}_{M} {e}^{\frac{j π}{4}}$ |
| 7 | β_{M} | ${β}_{M} {e}^{\frac{j 3 π}{2}}$ | β_{M}e^{jπ} | ${β}_{M} {e}^{\frac{j π}{2}}$ | β_{M} | ${β}_{M} {e}^{\frac{j 3 π}{2}}$ | β_{M}e^{jπ} | ${β}_{M} {e}^{\frac{j π}{2}}$ |
| 10 | β_{M} | ${β}_{M} {e}^{\frac{j π}{2}}$ | β_{M}e^{jπ} | ${β}_{M} {e}^{\frac{j 3 π}{2}}$ | β_{M} | ${β}_{M} {e}^{\frac{j π}{2}}$ | β_{M}e^{jπ} | ${β}_{M} {e}^{\frac{j 3 π}{2}}$ |

Jₚ = 7

| | | | | | | | | |
|---|---|---|---|---|---|---|---|---|
| 4 | β_{M} | ${β}_{M} {e}^{\frac{j 5 π}{4}}$ | ${β}_{M} {e}^{\frac{j π}{2}}$ | ${β}_{M} {e}^{\frac{j 7 π}{4}}$ | β_{M}e^{jπ} | ${β}_{M} {e}^{\frac{j π}{4}}$ | ${β}_{M} {e}^{\frac{j 3 π}{2}}$ | ${β}_{M} {e}^{\frac{j 3 π}{4}}$ |
| 7 | β_{M} | ${β}_{M} {e}^{\frac{j π}{2}}$ | β_{M}e^{jπ} | ${β}_{M} {e}^{\frac{j 3 π}{2}}$ | β_{M} | ${β}_{M} {e}^{\frac{j π}{2}}$ | β_{M}e^{jπ} | ${β}_{M} {e}^{\frac{j 3 π}{2}}$ |
| 10 | β_{M} | ${β}_{M} {e}^{\frac{j 7 π}{4}}$ | ${β}_{M} {e}^{\frac{j 3 π}{2}}$ | ${β}_{M} {e}^{\frac{j 5 π}{4}}$ | β_{M}e^{jπ} | ${β}_{M} {e}^{\frac{j 3 π}{4}}$ | ${β}_{M} {e}^{\frac{j π}{2}}$ | ${β}_{M} {e}^{\frac{j π}{4}}$ |

FIG. 5 shows a block diagram of a device 2 for estimating a carrier frequency offset (CFO) according to an embodiment of the present invention. As shown in FIG. 5, the device 2 for estimating CFO includes a pilot sequence detecting unit 200, a phase rotation vector estimating unit 210 and a CFO estimating unit 220. The pilot sequence detecting unit 200 is configured to detect a pilot sequence from a received signal. The phase information of the pilot sequence contains periodic mapping information of the pilot sequence on subcarriers. The phase rotation vector estimating unit 210 is configured to estimate a phase rotation vector due to a carrier frequency offset from the detected pilot sequence. The CFO estimating unit is configured to estimate the CFO based on the estimated phase rotation vector. The operation of the device 2 for estimating CFO will be detailed in the following.

Due to the presence of CFO in the system, each transmitter will cause a phase rotation vector with respect to the receiver, i.e.,

$${v}_{k} = {[ 1 , {e}^{\frac{j 2 π {ɛ}_{k}}{N}} , {e}^{\frac{j 2 π {ɛ}_{k} \times 2}{N}} , … , {e}^{\frac{j 2 π {ɛ}_{k} \times ( N - 1 )}{N}} ]}^{T} ,$$

where εₖ denotes the CFO of the k-th transmitter with respect to the receiver. Thus, the phase rotation vector estimating unit 210 estimates the phase rotation vector νₖ according to the following equation (3):

[symbol]

=Ξₖ^{†}y (3)

where Ξₖ^{†}=(Ξₖ^{H}Ξₖ)⁻¹Ξₖ^{H}, Ξₖ=diag{f_{O}^{T}\tilde{x}ₖ^{p}, . . . , f_{N-1}^{T}\tilde{x}ₖ^{p}}, fₖ denotes the k-th column vector of the IDFT matrix, \tilde{x}ₖ^{p} denotes the pilot vector transmitted from the k-th transmitter and y denotes the received vector.

Next, the CFO estimating unit 220 estimates the CFO based on the estimated phase rotation vector [symbol] =Ξₖ^{†}y according to the following equation (4):

$${\hat{ɛ}}_{k} = \frac{N \times arg \{ \hat{{v}_{k}} [ {θ}_{k} ] \}}{2 {πθ}_{k}} \qquad ( 4 )$$

where θₖ denotes the position of non-zero factor in the vector \hat{ν}\hat{νₖ} (by using this pilot sequence, there will be only one non-zero value in the estimated phase rotation vector [symbol] ).

In particular, the phase rotation information due to the presence of the CFO can be first estimated using an estimator which matches the pilot sequence. For different pilot sequences, the results estimated by the estimator (corresponding to the phase rotation information caused by the CFO of the target user) are orthogonal to each other as a result of the orthogonality between the pilot sequences. The estimated phase rotation vector corresponding to each pilot sequence contains only one non-zero element and, for different pilot sequences, the positions of their non-zero element are different from each other. Such characteristic ensures that the output phase rotation vectors corresponding to different pilot sequences are orthogonal to each other.

Thus, the CFO of the system can be estimated based on the non-zero element of the phase rotation vector corresponding to each pilot sequence. Since each estimated phase rotation vector contains only one non-zero value, the data in other zero-valued positions can only be interferences and noises. Once the receiver determines a target pilot sequence, it is capable of determining the non-zero position of the estimated phase rotation vector. After effectively filtering out the interferences and noises in other zero-valued positions, the receiver can estimate the CFO of the system very easily based on the non-zero estimated value in the phase rotation vector, e.g., by using the equation (4) as described above.

Therefore, compared with the conventional estimation schemes, the device 2 for estimating CFO according to this embodiment effectively suppresses the interferences and noises at the receiver, such that the estimation accuracy for the CFO as well as the SINR at the receiver can be effectively improved. In addition, the pilots from different transmitters can be identified and demodulated at the receiver, no matter how large the CFO in the system is.

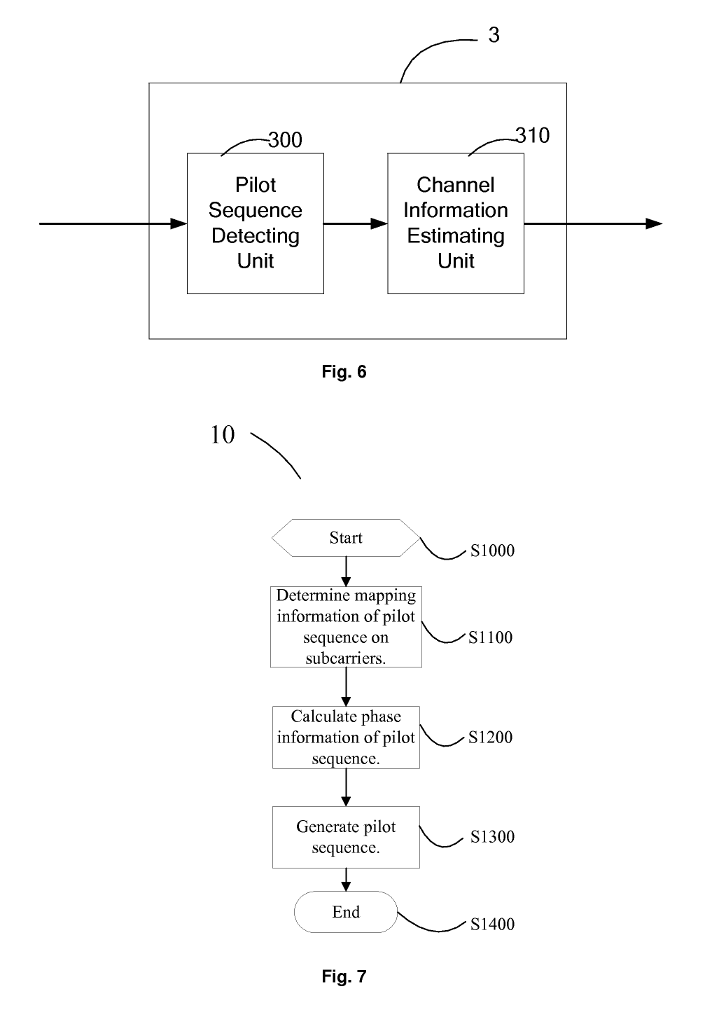

FIG. 6 shows a block diagram of a device 3 for estimating channel state information according to an embodiment of the present invention. As shown in FIG. 6, the device 3 for estimating channel station information includes a pilot sequence detecting unit 300 and a channel information estimating unit 310. The pilot sequence detecting unit 300 is configured to detect a pilot sequence from a received signal. The phase information of the pilot sequence contains periodic mapping information of the pilot sequence on subcarriers. The channel information estimating unit 310 is configured to estimate the channel information from the detected pilot sequence using a Least-Square algorithm. The operation of the device 3 for estimating channel state information will be detailed in the following.

The channel information estimating unit 310 estimates the channel state information by means of Least-Square (LS) channel information with reference to the following equation (5):

[symbol]

=P^{†}\tilde{r} (5)

where \tilde{r}=F^{H}y (F denotes a DFT matrix), the matrix P is defined as P=[P₁, . . . , P_{M}] (P^{†} denotes the pseudo-inverse of the matrix P and is defined as P^{l}=(P^{H}P)⁻¹P^{H}), Pᵢ=\sqrt{N}Eᵢ^{cir}Xᵢ^{p}F^{H}_{(L}_{ₘₐₓ}₎, Eᵢ^{cir}=F^{H}EᵢF, F_{(L}_{ₘₐₓ}₎ denotes a new matrix composed of the first F_{(L}_{ₘₐₓ}₎ rows of the matrix F, and

$${E}_{k} = diag \{ 1 , {e}^{\frac{j 2 π {ɛ}_{k}}{N}} , {e}^{\frac{j 2 π {ɛ}_{k} \times 2}{N}} , … , {e}^{\frac{j 2 π {ɛ}_{k} \times ( N - 1 )}{N}} \} ,$$

Thus, with the device 3 for estimating channel state information according to this embodiment, the pilot sequence can be effectively identified even if there is a CFO in the system. In addition, in this embodiment, the pilot sequence for channel estimation has a constant modulus.

Further, although not shown in FIGS. 5 and 6, the device 2 for estimating CFO and the device 3 for estimating channel state information according to the present invention can further include an input for receiving the channel estimation and an input for receiving the CFO, respectively. Based on the information provided at the additional inputs, it is possible to improve the CFO estimation and the channel information estimation since the channel state information can be used to optimize the CFO estimation and the CFO estimation result can be used to improve the performance of the channel estimation. This will be detailed in the following.

FIG. 7 shows a flowchart of a method 10 for generating a pilot sequence according to an embodiment of the present invention.

As shown in FIG. 7, the method 10 starts at step S1000. First, at step S1100, periodic mapping information of the pilot sequence on subcarriers (i.e., information on positions of the pilot sequence subcarriers) is determined. In particular, the mapping of the pilot sequence on the frequency subcarriers is periodic.

At step S1200, phase information of the pilot sequence to be generated is calculated based on the periodic mapping information. Then, at step S1300, the pilot sequence is generated based on the calculated phase information by using e.g., the above described equation (1) or (2).

Finally, the method 10 ends at step S1400.

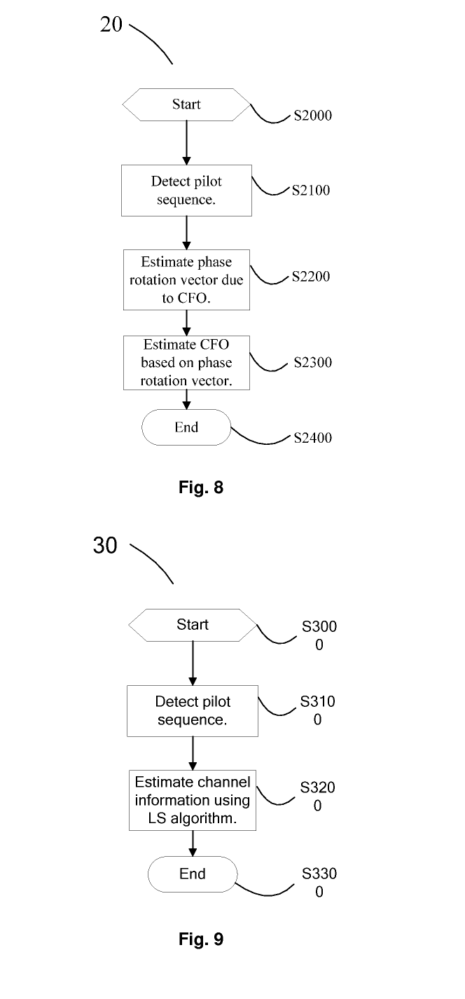

FIG. 8 shows a flowchart of a method 20 for estimating a carrier frequency offset according to an embodiment of the present invention.

As shown in FIG. 8, the method 20 starts at step S2000. First, at step S2100, a pilot sequence is detected from a received signal. The phase information of the detected pilot sequence contains periodic mapping information of the pilot sequence on subcarriers (as explained above).

Then, at step S2200, a phase rotation vector due to a carrier frequency offset is estimated from the detected pilot sequence based on the periodic mapping information by using e.g., the above described equation (3).

Next, at step S2300, the carrier frequency offset is estimated based on the estimated phase rotation vector by using e.g., the above described equation (4).

Finally, the method 20 ends at step S2400.

FIG. 9 shows a flowchart of a method 30 for estimating channel state information according to an embodiment of the present invention.

As shown in FIG. 9, the method 30 starts at step S3000. First, at step S3100, a pilot sequence is detected from a received signal. The phase information of the detected pilot sequence contains periodic mapping information of the pilot sequence on subcarriers (as explained above). Then, at step S3200, the channel information is estimated from the detected pilot sequence using a Least-Square algorithm by using e.g., the above described equation (5). Finally, the method 30 ends at step S3300.

Since the channel state information (CSI) can be used to optimize the CFO estimation algorithm and the result of CFO estimation can be used to improve the performance of channel estimation, an algorithm for jointly estimating a carrier frequency offset and channel information is provided according to an embodiment of the present invention and will be described below.

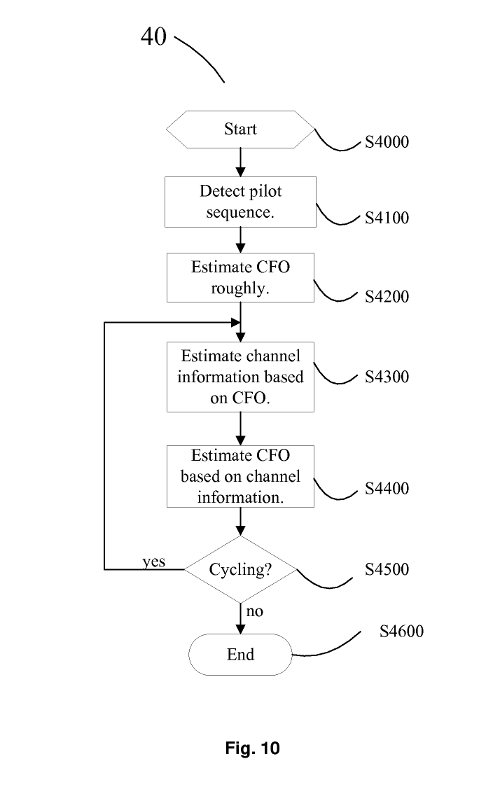

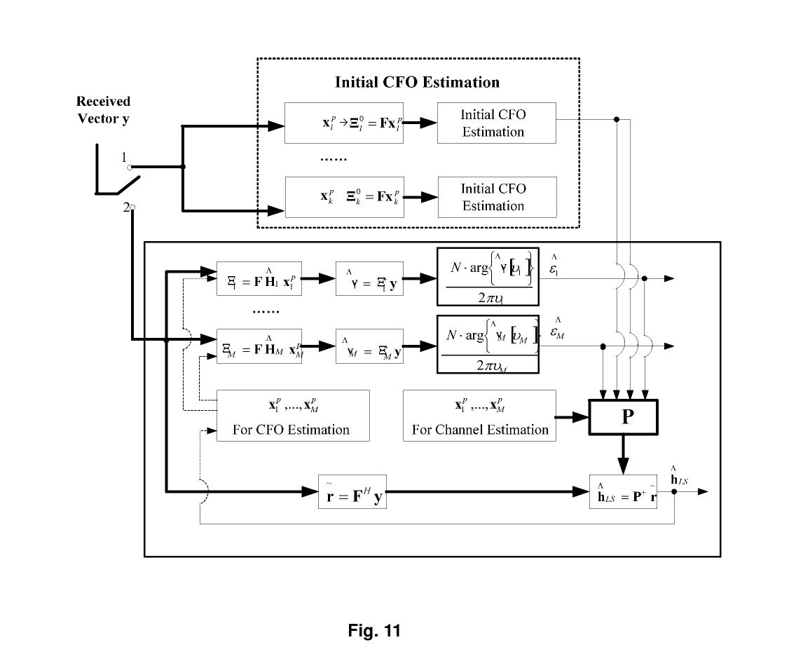

FIG. 10 shows a flowchart of a method 40 for estimating a carrier frequency offset and channel state information according an embodiment of the present invention. FIG. 11 shows a schematic diagram illustrating the principle of the method 40 for estimating a CFO and channel state information as shown in FIG. 10.

As shown in FIG. 10, the method 40 starts at step S4000. First, at step S4100, a pilot sequence is detected from a received signal. Then, at step S4200, a carrier frequency offset is initially estimated from the detected pilot sequence. It is to be noted that the initial estimation of the CFO at step S4200 is robust with respect to channel characteristics and can be performed in a number of ways in the art. Thus, the detailed description of this step is omitted here.

At step S4300, the channel information is estimated from the detected pilot sequence based on the initially estimated carrier frequency offset using a Least-Square algorithm (e.g., this step can be performed according to the step S3200 in FIG. 9 as described above).

At step 4400, a phase rotation vector due to a CFO is estimated from the detected pilot sequence based on the estimated channel information, and the carrier frequency offset is estimated based on the estimated phase rotation vector (e.g., this step can be performed according to the steps S2200 and S2300 in FIG. 8 as described above).

At step S4500, it is determined whether to perform the steps S4300 and S4400 in cycle or not as desired. Advantageously, the steps S4300 and S4400 can be performed in cycle to improve the accuracy of estimation of the CFO and the CSI.

If it is determined at step S4500 that the steps S4300 and S4400 are to be performed in cycle, the method returns to the step S4300; otherwise, the method is ends at step S4600.

FIG. 11 shows a schematic diagram illustrating the principle of the method 40 for estimating a carrier frequency offset and channel state information as shown in FIG. 10.

As shown in FIG. 11, the system is first connected to a point “1” for initial CFO estimation. After the initial CFO estimation, the system is connected to a point “2” for channel estimation. The result of the initial CFO estimation is useful to improve the accuracy of the channel estimation.

After the system performs the channel estimation, the result of the channel estimation can be fed back so as to be used for the CFO estimation.

It can be appreciated by one skilled in the art that the accuracy of estimation of the CFO and the CSI can be improved by performing the CFO and CSI estimations multiple times in cycle.

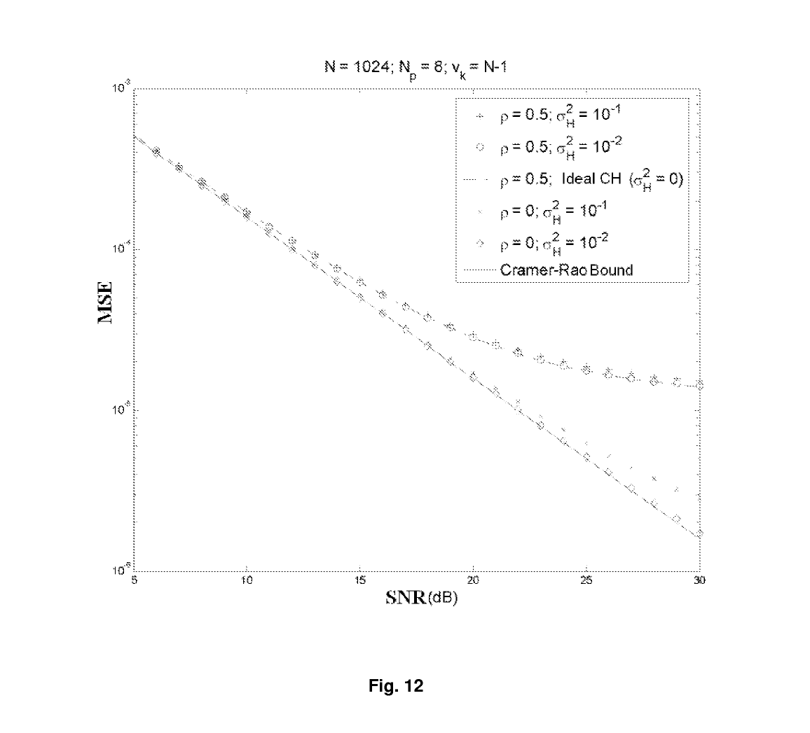

In the following, the performances of CFO estimation and channel estimation will be analyzed with reference to FIGS. 12-14.

FIG. 12 shows a graph illustrating the performance of carrier frequency offset estimation according to an embodiment of the present invention. As shown in FIG. 12, compared with the result in an ideal channel state, the loss in CFO estimation accuracy due to channel estimation error is very limited according to the present invention. The Cramer-Rao Lower Bound can always be reached in a high Signal to Noise Ratio (SNR) condition.

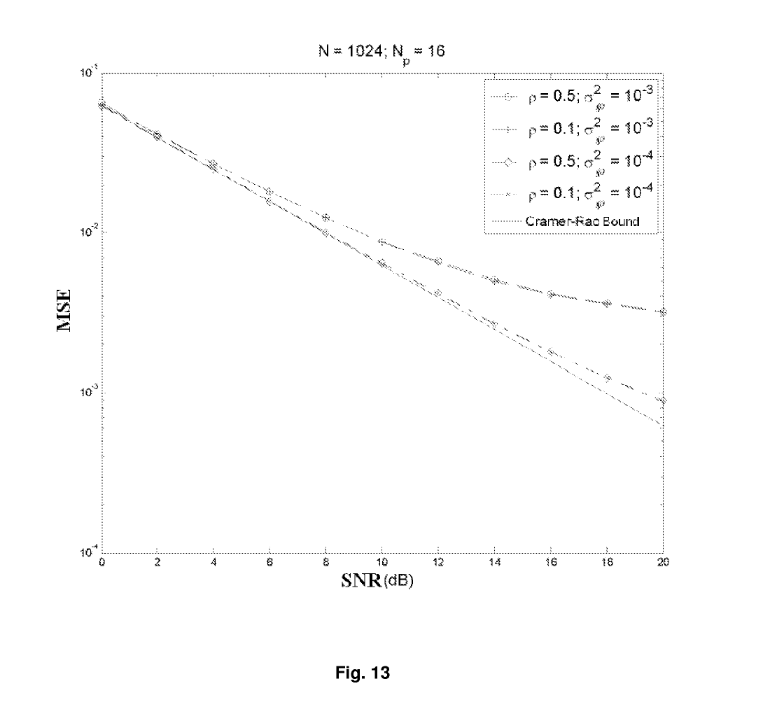

FIG. 13 shows a graph illustrating the performance of channel estimation according to an embodiment of the present invention. As shown in FIG. 13, the CFO has a significant impact on the performance of channel estimation algorithm. A reliable and stable channel estimation requires a CFO mean square error of less than 10⁻³ in the system. In an environment of high SNR and low CFO estimation error, the Cramer-Rao Lower Bound can be reached.

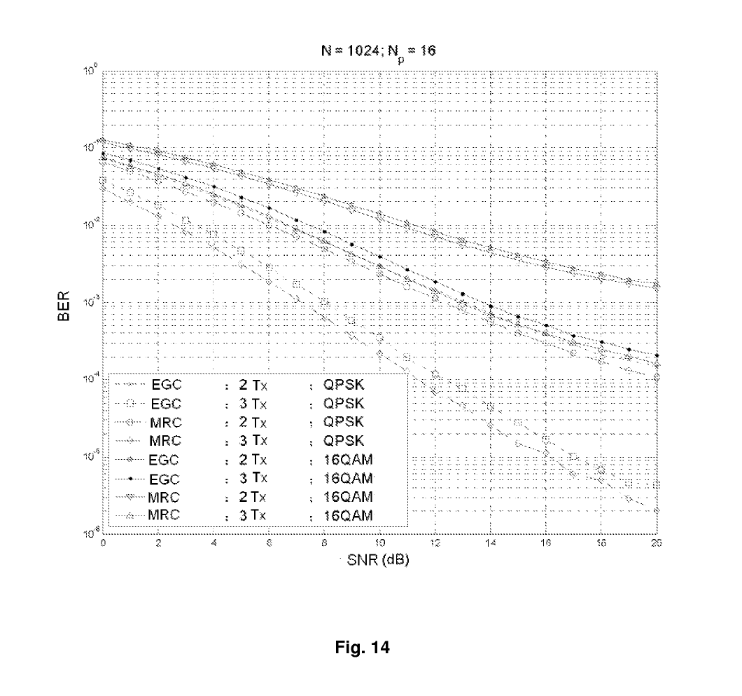

FIG. 14 shows a graph illustrating the bit error rate performance according to an embodiment of the present invention. As shown in FIG. 14, the data modulation schemes are assumed to be QPSK and 16 QAM. When the receiver is aware of the channel characteristics and the CFO value, the combining algorithms (such as Equal Gain Combining (EGC) and Maximum Ratio Combining (MRC)) at the receiver will effectively improve the bit error rate performance of the system. When the combining algorithms are adopted at the receiver, a joint transmission of more transmitters leads to a larger combining gain at the receiver.

With the pilot sequence generated according to the present invention, in the presence of a large CFO in a multipoint to point transmission system, it is possible to avoid failure of pilot sequence detection at the receiver due to the CFI in the prior art. Further, compared with the pilot detection based on frequency domain filter in the prior art, the pilot sequence detection process of the present invention is capable of avoiding loss of effective energy due to the presence of the CFO. In this way, the new pilot can achieve an improved CFO estimation accuracy.

The pilot sequence according to the present invention is very robust in pilot identification performance. The performance of pilot detection is independent of the CFO in the system. Thus, the pilot sequence of the present invention can be effectively applied to multipoint to point transmission environments such as SFN, OFDMA system and the like.

Additionally, the pilot sequence of the present invention is back-compatible and can be applied in conventional applications based on frequency domain filters.

While the present invention has been described above with reference to the preferred embodiments thereof, it can be appreciated by one skilled in the art that various modifications, alternatives and changes can be made without departing from the spirit and scope of the present invention. Therefore, the present invention is not limited to the above embodiments, but is defined by the attached claims and their equivalents.

1-15. (canceled)

16. A device for generating a pilot sequence, comprising:
a mapping information determining unit configured to determine periodic mapping information of the pilot sequence on subcarriers; and
a pilot sequence generating unit configured to generate the pilot sequence by calculating phase information of the pilot sequence to be generated based on the periodic mapping information.

17. The device according to claim 16, wherein the pilot sequence generating unit is configured to calculate a product of a number of the pilot sequence and the periodic mapping information and to calculate the phase information based on the product, thereby generating the pilot sequence.

18. The device according to claim 17, wherein the pilot sequence generating unit is configured to calculate a product of the number of the pilot sequence, the periodic mapping information and a predefined factor, and to calculate the phase information based on the product, thereby generating the pilot sequence,
wherein the predefined factor comprises a prime number which is no more than a total number of the subcarriers and is no less than a predetermined channel length.

19. The device according to claim 18, wherein the pilot sequence generated by the pilot sequence generating unit has a constant modulus value.

20. A device for estimating a carrier frequency offset, comprising:
a pilot sequence detecting unit configured to detect a pilot sequence from a received signal, the phase information of the pilot sequence containing periodic mapping information of the pilot sequence on subcarriers;
a phase rotation vector estimating unit configured to estimate a phase rotation vector due to a carrier frequency offset from the detected pilot sequence; and
a carrier frequency offset estimating unit configured to estimate the carrier frequency offset based on the estimated phase rotation vector.

21. The device according to claim 20, wherein the phase rotation vector estimating unit is configured to generate a matrix associated with the pilot sequence and perform a matrix operation on the received signal, in order to filter out interference and noise and retain valid information of the pilot sequence, thereby generating the phase rotation vector.

22. The device according to claim 20, wherein the phase rotation vector estimating unit comprises an input for receiving channel information, the phase rotation vector estimating unit estimating the carrier frequency offset based on the estimated phase rotation vector and the channel information received on the input.

23. A method for generating a pilot sequence, comprising:
a step of determining periodic mapping information of the pilot sequence on subcarriers; and
a step of generating the pilot sequence by calculating phase information of the pilot sequence to be generated based on the periodic mapping information.

24. The method according to claim 23, wherein the step of generating includes:
calculating a product of a number of the pilot sequence and the periodic mapping information; and
calculating the phase information based on the product, thereby generating the pilot sequence.

25. The method according to claim 24, wherein the step of generating includes:
calculating a product of a number of the pilot sequence, the periodic mapping information, and a predefined factor; and
calculating the phase information based on the product, thereby generating the pilot sequence,
wherein the predefined factor comprises a prime number which is no more than a total number of the subcarriers and is no less than a predetermined channel length.

26. The method according to claim 25, wherein the generated pilot sequence has a constant modulus value.
